(19) United States
(12) Patent Application Publication
(10) Pub. No.: US 2016/0044937 A1
(43) Pub. Date: Feb. 18, 2016

(54) METHODS FOR ENHANCING THE PALATABILITY OF LIQUID ANIMAL DIGESTS

(71) Applicant: NESTEC SA, Vevey (CH)

(72) Inventors: Pascal Vanacker, Amiens (FR); Patrick Pibarot, Montferrier sur Lez (FR)

(21) Appl. No.: 14/828,913

(22) Filed: Aug. 18, 2015

Related U.S. Application Data
(60) Provisional application No. 62/038,452, filed on Aug. 18, 2014.

(51) Int. Cl. A23K 1/00; A23K 1/18

(52) U.S. Cl. CPC A23K 1/007; A23K 1/004; A23K 1/1853

(57) ABSTRACT

Methods for enhancing the palatability of liquid animal digests comprise hydrolyzing a substrate, such as animal viscera, and then adjusting the pH of the hydrolysate to at least 8.0, preferably at least 8.5, and more preferably at least 9.5. The resultant hydrolysate can be added to a food composition to form a pet food product, such as a dry pet food product. For example, the hydrolysate can be coated onto dry kibbles. The pH can prevent growth of food pathogens, for example Salmonella.

### CROSS REFERENCE TO RELATED APPLICATIONS

This application claims priority to U.S. Provisional Application No. 62/038,452 filed Aug. 18, 2014, the disclosure of which is incorporated herein by this reference.

### BACKGROUND

The present disclosure relates generally to liquid animal digests and food products containing liquid animal digests and particularly to methods for enhancing the palatability of liquid animal digests. More specifically, the present disclosure is directed to using an alkaline pH to enhance the palatability of liquid digests formed by hydrolysis of animal protein.

Liquid animal digests are materials produced by chemical and/or enzymatic hydrolysis of clean and undecomposed animal tissue. Generally, the animal tissue does not include hair, horns, teeth, hooves or feathers, except in trace amounts that are unavoidable in normal manufacturing practices. Liquid animal digests are frequently applied to animal foods, such as dry pet foods, as natural flavoring that increases palatability of the animal foods and provides high-quality protein.

One of the traditional processes for producing liquid animal digests is based on autolysis, where endogenous enzymes are released from the animal tissue and then contribute to the hydrolysis of the animal tissue itself. Another hydrolysis process uses addition of enzyme-rich components to the starting material. Proteolytic enzymes from animal organs, such as pancreatin and pepsin, and from plants, such as bromelain of pineapple stems and papain of unripe papaya, have been used for this purpose, as well as technical enzymes such as proteases and lipases.

To stabilize the liquid animal digest for shelf-life, the existing liquid animal digests that are present on the market rely on an acidification step. For example, most serotypes of Salmonella will not grow at a pH below 4.5. Furthermore, acidification is typically used to stop the hydrolysis step. Therefore, known approaches to producing liquid animal digests involve acidification of the hydrolysate to a pH from 2.2 to 2.8.

### SUMMARY

The present inventors unexpectedly found that liquid animal digest adjusted by sodium hydroxide to a pH of at least 8.0 improved the palatability of dry dog food kibbles coated with the liquid animal digest compared to liquid animal digest from the same raw materials but adjusted by phosphoric acid to a pH of about 2.5. Specifically, animals had a 60:40 preference of kibbles coated with a liquid animal digest at pH 8.0 over kibbles coated with an identically formulated liquid animal digest at pH 2.8, and animals had a 75:25 preference of kibbles coated with a liquid animal digest at pH 9.6 over kibbles coated with an identically formulated liquid animal digest at pH 2.6.

Accordingly, in a general embodiment, the present disclosure provides method for enhancing the palatability of a digest. The method comprises: hydrolyzing a substrate with an enzyme to form a hydrolysate; and adjusting a pH of the hydrolysate to at least 8.0.

In an embodiment, the pH of the hydrolysate is adjusted to 8.0-10.0 after the hydrolyzing is completed.

In an embodiment, the hydrolyzing is performed at a temperature from about 40° C. to about 75° C. for from a time period from about 0.25 hours to about 4 hours.

In an embodiment, the enzyme comprises an endogenous protease of the substrate.

In an embodiment, the enzyme comprises an exogenous protease added to the substrate.

In an embodiment, the substrate is a non-milk protein.

In an embodiment, the substrate is animal viscera.

In an embodiment, the pH of the hydrolysate is adjusted by adding an alkaline compound to the hydrolysate. The alkaline compound can comprise an alkaline hydroxide.

In an embodiment, the pH of the hydrolysate is adjusted to at least 9.5.

In another embodiment, the present disclosure provides a method for enhancing the palatability of a food product. The method comprises: hydrolyzing a substrate with an enzyme to form a hydrolysate; adjusting a pH of the hydrolysate to at least 8.0; and adding the hydrolysate to a food composition, the food product comprises the hydrolysate added to the food composition.

In an embodiment, the food composition is a kibble, and the food product is a dry pet food.

In an embodiment, the adding of the hydrolysate to the food composition comprises coating at least part of the food composition with the hydrolysate.

In an embodiment, the method further comprises adding an additional comestible ingredient to the food composition. The adding of the additional comestible ingredient to the food composition can comprise coating at least part of the food composition with the additional comestible ingredient.

In an embodiment, the food product is formulated for consumption by a companion animal, and the substrate comprises animal viscera.

In another embodiment, the present disclosure provides a food product comprising: a pet food composition; and an animal digest having a pH of at least 8.0.

In an embodiment, the animal digest is coated on at least part of the pet food composition.

In an embodiment, the pet food composition is a kibble.

In an embodiment, the pet food composition is at least partially coated with a fat.

An advantage of the present disclosure is to provide a significant palatability improvement of liquid animal digests for pet food such as dry dogfood products.

Another advantage of the present disclosure is to improve palatability of liquid animal digests without major changes in process conditions at the digestion or reaction stage and without addition of alternative ingredients, thereby avoiding cost increases.

A further advantage of the present disclosure is to use an ingredient already present at the digest manufacturing site, such as sodium hydroxide, to improve palatability of liquid animal digests.

Still another advantage of the present disclosure is to improve palatability of liquid animal digests using pH adjustment that can be conducted in-line at the dry pet food manufacturing site or conducted at the digest manufacturing site.

Yet another advantage of the present disclosure is to improve palatability of liquid animal digests by directly substituting one ingredient, such as sodium hydroxide, for another previously-used ingredient, such as phosphoric acid, thereby preventing cost increases or even achieving cost savings.

Another advantage of the present disclosure is to improve palatability of liquid animal digests while still preventing growth of food pathogens therein.

Additional features and advantages are described herein and will be apparent from the following Detailed Description.

### DETAILED DESCRIPTION

As used in this disclosure and the appended claims, the singular forms “a,” “an” and “the” include plural referents unless the context clearly dictates otherwise. The words “comprise,” “comprises” and “comprising” are to be interpreted inclusively rather than exclusively. Likewise, the terms “include,” “including” and “or” should all be construed to be inclusive, unless such a construction is clearly prohibited from the context. However, the compositions and products disclosed herein may lack any element that is not specifically disclosed. Thus, a disclosure of an embodiment using the term “comprising” includes a disclosure of embodiments “consisting essentially of” and “consisting of” the components identified.

The terms “food,” “food product” and “food composition” mean a product or composition that is intended for ingestion by an animal and provides at least one nutrient to the animal. The term “pet” means any animal which could benefit from or enjoy the food compositions and products provided by the present disclosure. The pet can be an avian, bovine, canine, equine, feline, hicrine, lupine, murine, ovine, or porcine animal. The pet can be any suitable animal, and the present disclosure is not limited to a specific pet animal. The term “companion animal” means a dog or a cat.

The term “pet food” means any composition formulated to be consumed by a pet. “Dry food” is pet food having a water activity less than 0.65. “Semi-moist food” and “intermediate moisture food” is pet food having a water activity from 0.65 to 0.8. “Wet food” is pet food having a water activity more than 0.8. “Shelf-stable” means stable at ordinary temperatures for at least one year. “Comestible” means formulated to be eaten by a human or animal.

“Kibbles” are pieces of dry pet food which can have a pellet shape or any other shape. Non-limiting examples of kibbles include particulates; pellets; pieces of pet food, dehydrated meat, meat analog, vegetables, and combinations thereof; and pet snacks, such as meat or vegetable jerky, rawhide, and biscuits. The present disclosure is not limited to a specific form of the kibbles.

The terms “enhanced palatability” and “enhancing palatability” mean that an animal digest prepared according to the present disclosure, or a product comprising this animal digest, is more palatable than another animal digest, or a product comprising another animal digest, respectively. “Palatability” refers to a quality of a comestible composition that makes it appealing or pleasing to one or more of an animal's senses, particularly the senses of taste and smell. As used herein, whenever an animal shows a preference, for example, for one of two or more foods, the preferred food is more “palatable,” and has greater “palatability.” For companion animals and other non-human animals, the relative palatability of one food compared to one or more other foods can be determined, for example, in side-by-side, free-choice comparisons, e.g., by relative consumption of the foods, or other appropriate measures of preference indicative of palatability.

Ranges are used herein in shorthand to avoid listing every value within the range. Any appropriate value within the range can be selected as the upper value or lower value of the range. Moreover, the numerical ranges herein include all integers, whole or fractions, within the range.

All percentages expressed herein are by weight of the total weight of the food composition unless expressed otherwise. When reference is made to the pH, values correspond to pH measured at 25° C. with standard equipment. As used herein, “about” or “substantially” in reference to a number is understood to refer to numbers in a range of numerals, for example the range of −10% to +10%, preferably −5% to +5%, more preferably −1% to +1%, and even more preferably −0.1% to +0.1% of the referenced number.

The methods and compositions and other advances disclosed herein are not limited to particular methodologies, protocols, and reagents because, as the skilled artisan will appreciate, they may vary. Further, the terminology used herein is for the purpose of describing particular embodiments only and does not limit the scope of that which is disclosed or claimed.

Unless defined otherwise, all technical and scientific terms, terms of art, and acronyms used herein have the meanings commonly understood by one of ordinary skill in the art in the field(s) of the present disclosure or in the field(s) where the term is used. Although any compositions, methods, articles of manufacture, or other means or materials similar or equivalent to those described herein can be used, the preferred compositions, methods, articles of manufacture, or other means or materials are described herein.

The present disclosure provides a method for enhancing the palatability of animal digests. The method can comprise forming a hydrolysate from a substrate using at least one of (i) endogenous proteases from the substrate or (ii) exogenous proteases to hydrolyse proteins in the substrate. Then the pH of the hydrolysate can be adjusted to at least 8.0, such as 8.0-10.0; preferably to at least 8.5, such as 8.5-10.0; and more preferably to at least 9.5, such as 9.5-10.0. Such pH adjustment occurs before any other reaction steps, including thermal heating; cooling steps; or acidification steps. One advantage of the present disclosure is that the animal digest provides increased palatability without using significant amounts of pH adjustors that are typically requited with acidic methods.

The term “hydrolysate” refers to the product which results from hydrolysis of a substrate. The selection of a suitable substrate is based on the desired characteristics attained by the hydrolysate at the end of the process, specifically in terms of organoleptic properties and nutritional values. The substrate is preferably a non-milk protein substrate, more preferably an animal protein, even more preferably tissue from a farm animal such as poultry (e.g. any species or kind of bird, preferably chicken, turkey, or duck), beef, pork or lamb or from a seafood animal such as shrimp, fish or shellfish. In a particularly preferred embodiment, the substrate is viscera from chicken. A hydrolysate of animal protein is also referred to as an “animal digest” herein.

In an embodiment, the animal protein can be viscera obtained from any suitable source. Typically, viscera include the soft internal organs of the body, for example lungs, spleen, kidneys, brain, livers, low-temperature partially-defatted fatty tissue, and stomachs and intestines, freed of their contents; especially those organs contained within the abdominal and thoracic cavities. Additionally or alternatively to soft internal organs, viscera can include blood and/or bone. One example of the definition of viscera is given by the Association of American Feed Control Officials, Inc. (AAFCO). AAFCO generally defines viscera as all the organs in the three great cavities of the body (abdominal, thoracic, and pelvic) but defines viscera for fish as all organs in the great cavity of the body, including the gills, heart, liver, spleen, stomach, and intestines. Similarly AAFCO defines viscera for mammals as all organs in the great cavity of the body, including the esophagus, heart, liver, spleen, stomach, and intestines, but excludes the contents of the intestinal tract and defines viscera for poultry as all organs in the great cavity of the body, including the esophagus, heart, liver, spleen, stomach, crop, gizzard, undeveloped eggs, and intestines. In various embodiments, the viscera may be pretreated as known to skilled artisans, e.g., by stirring, homogenizing, emulsifying, and the like.

The endogenous and/or exogenous proteases are permitted to hydrolyze the substrate using any method known to skilled artisans. In preferred embodiments, the substrate-protease mixture is heated to increase enzyme activity and hydrolysis rate. The substrate-protease mixture can be heated using any suitable method, e.g., by direct steam injection, indirect heating via the vessel wall, or indirect steam heating in a jacketed vessel. Other methods are known to skilled artisans, e.g., heat exchangers. In an embodiment, the substrate-protease mixture is heated to about 35° C. to about 75° C. for a time period from about 0.25 to about 4 hours, preferably 0.5 to 2 hours, and most preferably 0.5 to 1 hour.

Preferably the hydrolysate is formed by endogenous proteases from the substrate. However, the method can additionally or alternatively comprise adding one or more exogenous proteases to the substrate. Any protease that is compatible with the substrate and that increases protein hydrolysis can be added. The protease can be any enzyme that is predominantly a protease, and the protease can have side activities such as lipolytic activity and/or phosphatasic activity.

The exogenous proteases can be an exopeptidase (e.g. Flavourzyme), such as an aminopeptidase, a carboxypeptidase, and a combination thereof; and/or an endopeptidase, such as trypsin, chymotrypsin, papain, elastase, Alcalase, Protemax, Neutrase, and combinations thereof. In various embodiments, the exogenous proteases are added in amounts of from about 0.01 to about 4%, preferably from about 0.05 to about 0.2%, most preferably from about 0.1 to about 1% by weight of the substrate-protease mixture. The exogenous proteases can be added to the mixture using any suitable method, generally by pouring the proteases into the mixture with stirring.

The pH of the hydrolysate can be adjusted using any method and compound or composition that is capable of affecting the pH of hydrolysate and compatible with hydrolysate. Such compounds or compositions are added in amounts sufficient to achieve the desired pH and include alkaline compounds e.g. alkaline hydroxides such as sodium hydroxide (NaOH) and/or potassium hydroxide (KOH), for example solutions of 25% or 50% NaOH. Generally, the pH-adjusting compounds are added to the hydrolysate with stirring. In a preferred embodiment, NaOH is added to and thoroughly mixed with the hydrolysate to increase the pH. Methods and techniques for measuring and adjusting pH are known to skilled artisans.

The liquid animal digest may be used to prepare a solid animal digest, such as by removing the water from liquid animal digest, for example by spray drying the digest to obtain a powder form of the digest.

The liquid animal digest can be added to a food composition, for example a pet food composition such as a kibble, to at least partially form a food product, such as a dry pet food. In an embodiment, extrusion is used to produce the food composition to which the liquid animal digest is then added, but the food composition can be any composition suitable for consumption by animals. In an embodiment, the liquid animal digest and the food composition are admixed to produce a food product. In another embodiment, the liquid animal digest and the food composition are admixed and subsequently mixed with an additional comestible ingredient, such as a fat (e.g. tallow), to produce the food product. In a preferred embodiment, the liquid animal digest is applied to the food composition, e.g., coated onto all or part of the food composition. The food composition can be coated with the fat (e.g. tallow) before and/or after being coated with the liquid animal digest.

The food composition that is mixed with the hydrolysate can be formulated for consumption by a pet such as a companion animal. For example, the food composition can comprise meat, such as emulsified meat. Examples of suitable meat include poultry, beef, pork, lamb and fish, especially those types of meats suitable for pets. The meat can include any additional parts of an animal including offal. Additionally or alternatively, vegetable protein can be used, such as pea protein, corn protein (e.g., ground corn or corn gluten), wheat protein (e.g., ground wheat or wheat gluten), soy protein (e.g., soybean meal, soy concentrate, or soy isolate), rice protein (e.g., ground rice or rice gluten) and the like.

The food composition that is mixed with the hydrolysate can comprise vegetable oil, a flavorant, a colorant and water. Suitable vegetable oils include soybean oil, corn oil, cottonseed oil, sunflower oil, canola oil, peanut oil, safflower oil, and the like. Examples of suitable flavorants include yeast, tallow, rendered animal meals (e.g., poultry, beef, lamb, pork), flavor extracts or blends (e.g., grilled beef), and the like. Suitable colorants include FD&C colors, such as blue no. 1, blue no. 2, green no. 3, red no. 3, red no. 40, yellow no. 5, yellow no. 6, and the like; natural colors, such as caramel coloring, annatto, chlorophyllin, cochineal, betanin, turmeric, saffron, paprika, lycopene, elderberry juice, pandan, butterfly pea and the like; titanium dioxide; and any suitable food colorant known to the skilled artisan.

The food composition that is mixed with the hydrolysate can optionally include additional ingredients, such as other grains and/or other starches additionally or alternatively to flour, amino acids, fibers, sugars, animal oils, aromas, other oils additionally or alternatively to vegetable oil, humectants, preservatives, polyols, salts, oral care ingredients, antioxidants, vitamins, minerals, probiotic microorganisms, bioactive molecules or combinations thereof.

Suitable starches include a grain such as corn, rice, wheat, barley, oats, soy and the like, and mixtures of these grains, and can be included at least partially in any flour. Suitable humectants include salt, sugars, propylene glycol and polyhydric glycols such as glycerin and sorbitol, and the like. Examples of preservatives that can be used include potassium sorbate, sorbic acid, methyl para-hydroxybenzoate, calcium propionate and propionic acid.

Suitable oral care ingredients include alfalfa nutrient concentrate containing chlorophyll, sodium bicarbonate, phosphates (e.g., tricalcium phosphate, acid pyrophosphates, alkaline pyrophosphates, tetrasodium pyrophosphate, metaphosphates, and orthophosphates), peppermint, cloves, parsley, ginger and the like. Examples of suitable antioxidants include butylated hydroxyanisole (“BHA”) and butylated hydroxytoluene (“BHT”), vitamin E (tocopherols), and the like.

Examples of vitamins that can be used include Vitamins A, B-complex (such as B-1, B-2, B-6 and B-12), C, D, E and K, niacin and acid vitamins such as pantothenic acid and folic acid and biotin. Suitable minerals include calcium, iron, zinc, magnesium, iodine, copper, phosphorus, manganese, potassium, chromium, molybdenum, selenium, nickel, tin, silicon, vanadium, boron and the like.

Specific amounts for each additional ingredient in the food composition that is mixed with the hydrolysate will depend on a variety of factors such as the ingredient included in the first edible material and any second edible material; the species of animal; the animal's age, body weight, general health, sex, and diet; the animal's consumption rate; the purpose for which the food product is administered to the animal; and the like. Therefore, the components and their amounts may vary widely.

Preferably the pH of the hydrolysate is adjusted to at least 9.5 if the pH adjustment is performed at one location and then the resultant hydrolysate added to the food composition (e.g., a kibble) at another location. In this regard, Salmonella has a pH range for growth of 3.8-9.5 under otherwise ideal conditions, and thus a pH of at least 9.5 can prevent growth of this pathogen. In an embodiment, for the hydrolysate that was stabilized at pH less than 3.5 after the hydrolysis at another location, a pH adjustment to at least 8.5 is performed just prior to application of the hydrolysate to the food composition.

However, if the pH adjustment is conducted in-line at the manufacturing site of the food composition to which the hydrolysate is added, preferably the pH of the hydrolysate is adjusted to at least 8.5. For example, the pH can be adjusted to at least 8.5 if the pH adjustment is substantially simultaneous to the mixing of the hydrolysate and the food composition (e.g. coating a kibble with the hydrolysate).

### EXAMPLES

The following non-limiting examples are illustrative of various embodiments provided by the present disclosure.

### Example 1

Uncoated kibbles were sampled at a dry dog food product manufacturing site. 89.8 kg of the dried kibbles were weighed into a tumble coater. The coater was started, and the 7.2 kg animal fat that was warmed to 60° C. was sprayed onto the tumbling kibbles. This was followed by 3 kg of liquid hydrolyzed acidified animal by-product (pH 2.6). The coated kibbles were tumbled for an additional 5 minutes after all the liquids were sprayed. The coated kibbles were then filled into poly bags and sealed. This was control dog product V.

### Example 2

100 kg of dry dog food test product was prepared using the process and formula as described for Example 1 with the following exceptions. The pH of the liquid hydrolyzed acidified by-product of Example 1 was raised to pH 9.6 using a solution of 25% Sodium Hydroxide.

### Example 3

Another 100 kg of dry dog food test product was prepared using the process and formula as described for Example 1 with the following exception. A different lot of the liquid hydrolyzed acidified by-product (pH 2.5) of Example 1 was used. This was control dog product W.

### Example 4

Palatability comparisons were made for test (A) dry dog food products sprayed with liquid hydrolyzed animal by-product at pH 9.6 (Example 2) and control products (B) which had a liquid hydrolyzed acidified animal by-product at pH 2.6 (Example 1) or at pH 2.5 (Example 3). Palatability feeding tests were carried out using a 2 bowl paired comparison procedure. Pairs of products fed were Example 2 versus Example 1; and Example 2 versus Example 3. The pair of bowls with weighed amount of products was presented to a dog for 20 minutes, or when one bowl was empty if sooner. For each bowl the difference in weight after the test was the amount consumed. For each comparison, 24 dogs were fed and the average % consumption of each product determined. Results are shown in Table 1. It is clearly seen that the test products with liquid hydrolyzed animal by-product at pH 9.6 had higher consumption than their respective controls with liquid hydrolyzed acidified animal by-product at pH 2.5 or at 2.6.

TABLE 1
% Consumption A versus B

B

| A | Control Dog Product V | Control Dog Product W |
|---|---|---|
| Example 2 | (Example 1) | (Example 3) |
| 81.2 | 18.8 | — |
| 65.0 | — | 35.0 |

### Example 5

A different batch of uncoated kibbles was sampled at a dry dog food product manufacturing site. 89.8 kg of the dried kibbles were weighed into a tumble coater. The coater was started, and the 7.2 kg animal fat that was warmed to 60° C. was sprayed onto the tumbling kibbles. This was followed by 3 kg of liquid hydrolyzed acidified animal by-product (pH 2.4). The coated kibbles were tumbled for an additional 5 minutes after all the liquids were sprayed. The coated kibbles were then filled into poly bags and sealed. This was Control Dog Product X.

### Example 6

100 kg of dry dog food test product was prepared using the process and formula as described for Example 5 with the following exception. The pH of the liquid hydrolyzed acidified by-product of Example 5 was raised to pH 9.5 using a solution of 25% Sodium Hydroxide.

### Example 7

100 kg of a second control dry dog food product was prepared using the process and formula as described for Example 5 with the following exception. A different lot of liquid hydrolyzed acidified by-product (pH 2.8) was used. This was Control Dog Product Y.

### Example 8

Palatability comparisons were made for test dry dog food product (A) sprayed with liquid hydrolyzed animal by-product at pH 9.5 (Example 6), and control products (B) which had a liquid hydrolyzed acidified animal by-product at pH 2.4 (Example 5) or at pH 2.8 (Example 7) as for Example 4. Results are shown in Table 2. It is clearly seen that the test products with liquid hydrolyzed animal by-product at pH 9.5 had higher consumption than their respective controls with liquid hydrolyzed acidified animal by-product at pH 2.4 or 2.8.

TABLE 2
% Consumption A versus B

B

| A | Control Dog Product X | Control Dog Product Y |
|---|---|---|
| Example 6 | (Example 5) | (Example 7) |
| 73.1 | 26.9 | — |
| 74.2 | — | 25.8 |

### Example 9

Uncoated kibbles from another variety of dry dog product were sampled at the manufacturing site. 91.9 kg of the dried uncoated kibbles were weighed into a tumble coater. The coater was started, and 5.7 kg animal fat that was warmed to 60° C. was sprayed onto the tumbling kibbles. This was followed by 2.4 kg of liquid hydrolyzed acidified animal by-product (pH 2.4). The coated kibbles were tumbled for an additional 5 minutes after all the liquids were sprayed. The coated kibbles were then filled into poly bags and sealed. This was control dog product 1.

### Example 10

100 kg of a second control dog product 2 was made as in Example 9 except that the order of application of tallow and liquid hydrolyzed acidified animal by-product was reversed.

### Example 11

100 kg of dry dog food test product was prepared using the process and formula as described for Example 9 with the following exception. The pH of the liquid hydrolyzed acidified by-product of Example 9 was raised to pH 8.0 using a solution of 25% Sodium Hydroxide.

### Example 12

Palatability comparisons were made for test dry dog food product (A) sprayed with liquid hydrolyzed animal by-product at pH 8.0 (Example 11) and control products (B) which had liquid hydrolyzed acidified animal by-product at pH 2.4 (Example 9) and (Example 10) as for Example 4. Results are shown in Table 3. It is clearly seen that the test products with liquid hydrolyzed animal by-product at pH 8.0 had higher consumption than the control with liquid hydrolyzed acidified animal by-product at pH 2.4 regardless of the order of application of it and tallow to the uncoated kibbles.

TABLE 3
% Consumption A versus B

B

| A | Control Dog Product 1 | Control Dog Product 2 |
|---|---|---|
| Example 11 | (Example 9) | (Example 10) |
| 63.2 | 36.8 | — |
| 59.8 | — | 40.2 |

### Example 13

Uncoated kibbles from another variety of dry dog product were sampled at the manufacturing site. 90.3 kg of the dried uncoated kibbles were weighed into a tumble coater. The coater was started, and the 6.2 kg animal fat that was warmed to 60° C. was sprayed onto the tumbling kibbles. This was followed by 3.5 kg of liquid hydrolyzed acidified animal by-product (pH 2.9). The coated kibbles were tumbled for an additional 5 minutes after all the liquids were sprayed. The coated kibbles were then filled into poly bags and sealed. This was the control dog product Z.

### Example 14

100 kg of dry dog food test product was prepared using the process and formula as described for Example 13 with the following exception. The pH of the liquid hydrolyzed acidified by-product of Example 13 was raised to pH 8.05 using a solution of 25% Sodium Hydroxide.

### Example 15

100 kg of a second dry dog food test product was prepared using the process and formula as described for Example 13 but with the order of application of tallow and hydrolysates reversed. The coater was started, and 3.5 kg of liquid hydrolyzed animal by-product of pH 8.05 prepared as in Example 14 was sprayed onto the tumbling kibbles. This was followed by 6.2 Kg of animal fat that was warmed to 60° C.

### Example 16

Palatability comparisons were made for test dry dog food products (A) at pH 8.05 (Example 14 or Example 15 respectively) and control product Z (B), at pH 2.9 (Example 13). Palatability tests were done as in Example 4 for pairs of products Example 14 versus Example 13; and Example 15 versus Example 13. Results are shown in Table 4. It is clearly seen that the test products with liquid hydrolyzed animal by-product at pH 8.05 had higher consumption than the control with liquid hydrolyzed acidified animal by-product at pH 2.9 regardless of the order of application of it and tallow onto the kibbles.

TABLE 4
% Consumption A versus B

| | | B |
|---|---|---|
| | | Control Dog Product Z |
| | A | (Example 13) |
| Example 14 | 60 | 40 |
| Example 15 | 62.5 | 37.5 |

### Example 17

100 kg of Control Dog Product 3 was prepared as follows. A different batch of uncoated kibbles was sampled at a dry dog product manufacturing site. 90.5 kg of the dried kibbles were weighed into a tumble coater. The coater was started, and the 6 kg animal fat that was warmed to 60° C. was sprayed onto the tumbling kibbles. This was followed by 3.5 kg of liquid hydrolyzed acidified animal by-product (pH 2.6). The coated kibbles were tumbled for an additional 5 minutes after all the liquids were sprayed. The coated kibbles were then filled into poly bags and sealed.

### Example 18

100 kg of a second Control Dog Product 4 was prepared as in Example 17 with the following exception. The liquid hydrolyzed acidified by-product used was from a different lot and pH was also 2.6.

### Example 19

100 kg of dry dog food test product was prepared using the process and formula as described for Example 17 with the following exception. The pH of the liquid hydrolyzed acidified by-product of Example 17 was raised to pH 10.1 using a solution of 25% Sodium Hydroxide.

### Example 20

100 kg of a second dry dog food test product was prepared using the process and formula as described for Example 18 with the following exception. The liquid hydrolyzed acidified by-product used was the same lot as the one of Example 18 and its pH was raised to pH 10.1 using a solution of 25% Sodium Hydroxide.

### Example 21

Palatability comparisons were made for test dry dog food products (A) at pH 10.1 versus control products (B) made with liquid hydrolyzed acidified by-products (pH 2.6). Palatability tests were done as in Example 4 for pairs of products Example 19 versus Example 17; and Example 20 versus Example 18. Comparisons were made in duplicate. Results are shown in Table 5. It is clearly seen that the test products with liquid hydrolyzed animal by-product at pH 10.1 were similar or even trended lower than respective control products with liquid hydrolyzed acidified animal by-product at pH 2.6. Thus the positive impact of the higher pH liquid hydrolyzed animal by-product seen in previous examples at pH 8-9.6 is lost at pH 10.1.

TABLE 5
% Consumption A versus B

| A | | B | |
|---|---|---|---|
| Example | Example | Control Dog Product 3 | Control Dog Product 4 |
| 19 | 20 | (Example 17) | (Example 18) |
| 52.3 | — | 48.7 | — |
| 40.7 | — | 58.3 | — |
| | 41.0 | — | 59.0 |
| | 45.1 | — | 54.9 |

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A method for enhancing the palatability of a digest comprising:
hydrolyzing a substrate with an enzyme to form a hydrolysate; and
adjusting a pH of the hydrolysate to at least 8.0.

2. The method of claim 1 wherein the pH of the hydrolysate is adjusted to 8.0-10.0 after the hydrolyzing is completed.

3. The method of claim 1 wherein the hydrolyzing is performed at a temperature from about 40° C. to about 75° C. for from a time period from about 0.25 hours to about 4 hours.

4. The method of claim 1 wherein the enzyme comprises an endogenous protease of the substrate.

5. The method of claim 1 wherein the enzyme comprises an exogenous protease added to the substrate.

6. The method of claim 1 wherein the substrate is a non-milk protein.

7. The method of claim 1 wherein the substrate is animal viscera.

8. The method of claim 1 wherein the pH of the hydrolysate is adjusted by adding an alkaline compound to the hydrolysate.

9. The method of claim 8 wherein the alkaline compound comprises an alkali hydroxide.

10. The method of claim 1 wherein the pH of the hydrolysate is adjusted to at least 9.5.

11. A method for enhancing the palatability of a food product comprising:
hydrolyzing a substrate with a protease to form a hydrolysate;
adjusting a pH of the hydrolysate to at least 8.0; and
adding the hydrolysate to a food composition, the food product comprises the hydrolysate added to the food composition.

12. The method of claim 11 wherein the food composition is a kibble, and the food product is a dry pet food.

13. The method of claim 11 wherein the adding of the hydrolysate to the food composition comprises coating at least part of the food composition with the hydrolysate.

14. The method of claim 11 further comprising adding an additional comestible ingredient to the food composition.

15. The method of claim 14 wherein the adding of the additional comestible ingredient to the food composition comprises coating at least part of the food composition with the additional comestible ingredient.

16. The method of claim 11 wherein the food product is formulated for consumption by a companion animal, and the substrate comprises animal viscera.

17. A food product comprising:
a pet food composition; and
an animal digest having a pH of at least 8.0.

18. The food product of claim 17 wherein the animal digest is coated on at least part of the pet food composition.

19. The food product of claim 17 wherein the pet food composition is a kibble.

20. The food product of claim 17 wherein the pet food composition is at least partially coated with a fat.
